(19) United States
(12) Patent Application Publication
(10) Pub. No.: US 2020/0087853 A1
(43) Pub. Date: Mar. 19, 2020

(54) Warp-Knit Structure Suitable For Vehicular Accessory Mat Or Cargo Management System

(71) Applicant: AURIA SOLUTIONS UK I LTD., London (GB)

(72) Inventors: Ernest Franklin Wilson, Albemarle, NC (US); Tyler M. Heath, Mount Gilead, NC (US); Sean Bracken Simmons, Concord, NC (US); Rodney Gene Dyer, Thomasville, NC (US)

(21) Appl. No.: 16/547,524

(22) Filed: Aug. 21, 2019

Related U.S. Application Data
(60) Provisional application No. 62/720,861, filed on Aug. 21, 2018.

(51) Int. Cl. D06N 7/00; B60R 5/04; B60N 3/04

(52) U.S. Cl. CPC D06N 7/0071; B60R 5/04; D06N 2209/106; D06N 2211/263; B60N 3/046

(57) ABSTRACT

A warp-knit structure that is particularly suited to provide an acceptable coefficient of friction (COF) for a vehicle accessory mat or vehicle cargo management system when used with non-woven or tufted type flooring. The floor mat or cargo management system is therefore one that is adapted for repeated engagement and disengagement with both non-woven and tufted flooring present in a vehicle.

### CROSS-REFERENCE TO RELATED APPLICATIONS

The present application claims the benefit of the filing date of U.S. Provisional Application, Ser. No. 62/720,861, filed Aug. 21, 2018, the teachings of which are incorporated herein by reference.

### FIELD

The present invention relates to a warp-knit structure that is particularly suited to provide an acceptable coefficient of friction (COF) for a vehicle accessory mat or cargo management system when used with non-woven or tufted type flooring.

### BACKGROUND

Vehicular accessory mats are often utilized to protect an underlying floor surface of a vehicle from dirt and other contaminants that may be supplied in the footwear of a driver or passenger. It is an important requirement that such mats should be removable and not slip although they may be removed from the underlying carpeted floor.

More generally, in a given vehicle, a long-standing concern is that floor mats may shift or move from a desired position in response to lateral forces that may occur when the occupant enters or leaves the vehicle or during driving. On the driver's side, this can become a safety issue to the extent that the mat may then interfere with the driver's ability to engage with the accelerator or brake pedal.

Accessory mats therefore require some means of back treatment to prevent mat movement, which has included the use of nibs, adhesive coated non-wovens and singed non-wovens. These solutions have indicated some success on tufted or non-woven floors, but not both. Accordingly, there remains a need for knit structure capable of meeting all OEM requirements with respect to coefficient of friction (COF) requirements that would avoid the use of nibs or custom tooling, and be suitable for use on both tufted and non-woven surfaces.

### SUMMARY

A vehicle floor mat comprising:
an upper surface layer that is exposed to vehicle occupants;
a backing layer of a warp-knit structure affixed to said upper surface layer having knitted loops, said backing layer having a thickness of 3.0 mm to 3.5 mm, a fiber denier of 15-80 and 144-216 spines/inch and wherein 50% or more of the knitted loops are cut or sheared;
wherein said backing layer indicates a static coefficient of friction under ASTM D1894-11 on:
(i) non-woven flooring of 5-10 in the warp direction and 4-7 in the weft direction; and
(ii) tufted flooring of 2.5-4.0 in the warp direction and 2.5-4.0 in the weft direction.

A vehicle floor mat comprising:
an upper surface layer that is exposed to vehicle occupants;
a backing layer of a warp-knit structure affixed to said upper surface layer having knitted loops, said backing layer having a thickness of 2.0 mm to 4.0 mm, a fiber denier of 2-20 and 450-625 spines/inch and wherein 50% or more of the knitted loops are cut or sheared;
wherein said backing layer indicates a static coefficient of friction under ASTM D1894-11 on:
(i) non-woven flooring of 5-10 in the warp direction and 4-7 in the weft direction; and
(ii) tufted flooring of 2.5-4.0 in the warp direction and 2.5-4.0 in the weft direction.
A free-standing cargo-management device for vehicle flooring comprising a primary wall and a projecting ground wall extending from the primary wall, wherein the surface of the ground wall that is configured to contact the vehicle flooring includes a layer of a warp-knit structure having knitted loops, said layer having a thickness of 3.0 mm to 3.5 mm, a fiber denier of 15-80 and 144-216 spines/inch and wherein 50% or more of the knitted loops are cut or sheared;
wherein said layer of warp-knit structure indicates a static coefficient of friction under ASTM D1894-11 on:
(i) non-woven flooring of 5-10 in the warp direction and 4-7 in the weft direction; and
(ii) tufted flooring of 2.5-4.0 in the warp direction and 2.5-4.0 in the weft direction.
A free-standing cargo management device for vehicle flooring comprising a primary wall and a projecting ground wall extending from the primary wall, where the surface of the ground wall that is configured to contact the vehicle flooring includes a layer of a warp-knit structure having knitted loops, said layer having a thickness of 2.0 mm to 4.0 mm, a fiber denier of 2-20 and 450-625 spines/inch and wherein 50% or more of the knitted loops are cut or sheared;
wherein said layer of warp-knit structure indicates a static coefficient of friction under ASTM D1894-11 on:
(i) non-woven flooring of 5-10 in the warp direction and 4-7 in the weft direction; and
(ii) tufted flooring of 2.5-4.0 in the warp direction and 2.5-4.0 in the weft direction.

### BRIEF DESCRIPTION OF THE FIGURES

FIG. 1 illustrates a relative heavy denier warp-knit structure with a relatively lower spine density.

FIG. 2 illustrates a relatively finer denier warp-knit structure at a relatively high spine density.

FIG. 3 illustrates a free-standing cargo management device configured to utilize the warp-knit structure herein.

### DETAILED DESCRIPTION OF PREFERRED EMBODIMENTS

The present invention is directed a warp-knit structure for an accessory mat or cargo management system that provides a requisite coefficient of friction (COF) satisfying OEM requirements for both non-woven and tufted vehicle flooring. As noted, the structure herein is preferably a warp-knitted textile fabric, and more preferably a raschel knitted fabric. A raschel knitted textile fabric is reference to a warp-knitted fabric in which the resulting knit fabric produces what can be described as a relatively openwork fabric. In raschel knitting, the fabric is formed in line with the movement of the needles. FIG. 1 illustrates a structure of a warp knitted fabric 10. The fabric includes a plurality of loops 12 that extend mainly lengthwise in the vertical direction 14. The yarns that may be employed to produce the warp knitted fabric 10 preferably include, but are not limited to synthetic fibers, sourced from polyamide, polyester, polyurethane, polypropylene or polyethylene.

The term “warp” is reference to the yarns in the fabric that run lengthwise and the “weft” refers to the yarns in the fabric that run generally perpendicular to the warp yarns. That is, a warp-knitted fabric herein may be understood as being formed from a process wherein a number of threads are arranged in longitudinal and horizontal direction and are bound together by formation of stitches and in which the loops made from each warp thread are, as noted formed mainly along the length of the fabric. The additional term “spines” herein refer to the number of individual threads of a given denier on the surface of the fabric.

The warp-knitted fabric herein is preferably one that is a warp-knitted textile fabric at a pile thickness in the range of 2.0 mm to 4.0 mm and a fiber denier in the range of 5-80. More preferably, the warp-knitted fabric herein is one that is formed in two configurations. A first configuration preferably comprises a warp-knitted textile fabric at thickness in the range of 3.0 mm to 3.5 mm, more preferably 3.1 mm to 3.3 mm, fiber denier in the range of 15-80, with 144-216 spines/inch². More preferably, the fiber denier may be in the range of 20-50 denier. A second configuration preferred configuration also comprises a warp-knitted textile fabric at a thickness in the range of 2.0 to 4.0 mm, fiber denier in the range of 2-20 denier, more preferably 5-15 denier, with 450-625 spines/inch². Both of these preferred configurations may then be used directly on non-woven surfaces. They may then be preferably brushed with a wire brush to improve frictional engagement and are then observed to be suitable for use on both non-woven and tufted flooring. Reference to such brushing is reference to the feature that the knitted loops are preferably cut or sheared by such brushing which surprisingly provides the coefficient of friction performance discussed below, on non-woven and/or tufted floor systems, in either the warp or weft direction. For example, for a given vehicle floor mat herein, the warp-knit structure is one in which 50% or more of the knitted loops are cut or sheared. More preferably, 60% or more, or 70% or more, or 80% or more, or 90% or more of the knitted loops are cut or sheared, which as noted, is achieved by a brushing procedure. It is worth noting that the brushing is preferably applied after lamination of the warp-knitted fabric herein to an appropriate backing material, such as a latex coating including a thermoplastic, such as a polyolefin (e.g. polyethylene) material.

As alluded to above, the warp-knitted structure herein provides a very desirable static coefficient of friction set forth in ASTM D1894-11, entitled Static and Kinetic Coefficients of Friction of Plastic Film and Sheeting, approved Sep. 1, 2011, published September 2011, in both vertical and horizontal directions for both tufted and non-woven flooring. The static coefficient of friction as measured by ASTM D1894-11 is greater than 2.0, more preferably in the range of 2.0-12.0. More specifically, for non-woven floor systems the warp-knit structure herein indicates a static coefficient of friction from 5-10 in the warp direction and 4-7 in the weft direction. For a tufted floor system, the warp-knit structure herein indicates a static coefficient of friction from 2.5 to 4.0 in the warp direction and 2.5 to 4.0 in the weft direction.

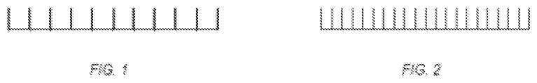

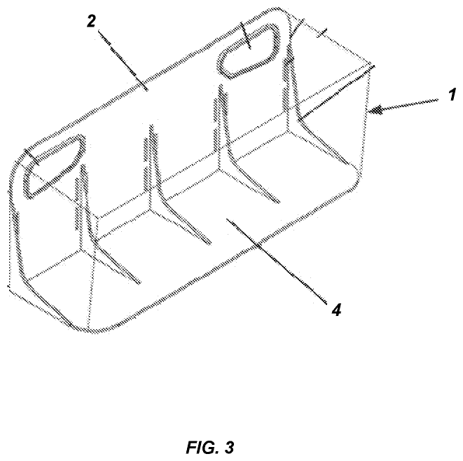

Attention is next directed to FIGS. 1 and 2, which illustrate two preferred embodiments of the present invention. FIG. 1 is intended to illustrate the use of a relatively heavier denier with a relatively lower spine density, e.g. a value of about 180 spines/in². FIG. 2 is intended to illustrate the use of a finer denier at a relatively higher spine density, e.g., a value of about 546 spines/in². In addition, with respect to the spines, it may now be appreciated that the spines are such that they generally oriented at an angle of 75° to 105° to the structure, more preferably in the range of 85° to 95°. By configuring the fibers with such angular characteristics, the above referenced properties and COF values are now more readily achieved.

As alluded to above, the warp-knit structure herein may then itself become a portion of a laminated structure that includes different layers. For example, the warp-knit structure herein which is adapted for engagement and disengagement with either a non-woven or tufted vehicle flooring, may be understood as providing a backing layer on the vehicle mat which is then on its own preferably supplied with a bonding layer which is then bonded to a filament bonding layer which then can engage with an upper surface layer that is exposed in the vehicle to the passengers. Such upper surface may therefore preferably comprise, e.g., pile fabric on the surface of the mat.

In sum, the warp-knit structure herein, that is preferably brushed to cut or shear the loops therein, provides an unexpected and improved solution to the issue of accessory mat slippage within vehicles, and achieves frictional performance requirements for both non-woven and tufted flooring that satisfies OEM requirements.

In addition, the warp-knit structure herein is one that may be applied to control slippage in cargo management system, which may be understood as a free-standing device for management of cargo in a vehicle. Such cargo management device may be utilized, for example, to secure and immobilize cargo against a vehicle trim panel. As illustrated in FIG. 3, the free-standing cargo management device 1 generally includes a primary wall 2 and at least one projecting wall 4 extending from the primary wall where the bottom of the projecting wall is configured to rest on a vehicle surface. Accordingly, in preferred embodiments the projecting wall 4 is a ground wall, which projects from the base of the primary wall. The primary wall 2 and projecting wall 4 preferably provide a generally “L” shaped object. While FIG. 1 illustrates the primary wall 2 meeting the projecting wall at 90 degrees, it may be appreciated that the primary wall 2 may be set at an angle a relative to the projecting wall that is less than 90 degrees, such as in the range of 30 to 80 degrees. Accordingly, the warp-knit structure herein may be applied to the ground wall 4 that is configured to engage the vehicle surface to provide the referenced COF properties with respect to a non-woven or tufted flooring as described herein.

In addition, it should be noted that the warp-knit structure herein is such that when applied to, e.g., a nonwoven surface, as noted herein, the COF is such that it will resist movement in the horizontal plane (left, right, fore or aft in the vehicle). However, when lifted in the “z” direction, the warp-knit structure herein avoids pull-out of the vehicle non-woven surface fibers, which can then compromise the integrity or appearance of the vehicle non-woven surface.

1. A vehicle floor mat comprising:
an upper surface layer that is exposed to vehicle occupants;
a backing layer of a warp-knit structure affixed to said upper surface layer having knitted loops, said backing layer having a thickness of 3.0 mm to 3.5 mm, a fiber denier of 15-80 and 144-216 spines/inch and wherein 50% or more of the knitted loops are cut or sheared;
wherein said backing layer indicates a static coefficient of friction under ASTM D1894-11 on:
(iii) non-woven flooring of 5-10 in the warp direction and 4-7 in the weft direction; and
(iv) tufted flooring of 2.5-4.0 in the warp direction and 2.5-4.0 in the weft direction.

2. A vehicle floor mat comprising:
an upper surface layer that is exposed to vehicle occupants;
a backing layer of a warp-knit structure affixed to said upper surface layer having knitted loops, said backing layer having a thickness of 2.0 mm to 4.0 mm, a fiber denier of 2-20 and 450-625 spines/inch and wherein 50% or more of the knitted loops are cut or sheared;
wherein said backing layer indicates a static coefficient of friction under ASTM D1894-11 on:
(iii) non-woven flooring of 5-10 in the warp direction and 4-7 in the weft direction; and
(iv) tufted flooring of 2.5-4.0 in the warp direction and 2.5-4.0 in the weft direction.

3. A free-standing cargo-management device for vehicle flooring comprising a primary wall and a projecting ground wall extending from the primary wall, wherein the surface of the ground wall that is configured to contact the vehicle flooring includes a layer of a warp-knit structure having knitted loops, said layer having a thickness of 3.0 mm to 3.5 mm, a fiber denier of 15-80 and 144-216 spines/inch and wherein 50% or more of the knitted loops are cut or sheared;
wherein said layer of warp-knit structure indicates a static coefficient of friction under ASTM D1894-11 on:
(v) non-woven flooring of 5-10 in the warp direction and 4-7 in the weft direction; and
(vi) tufted flooring of 2.5-4.0 in the warp direction and 2.5-4.0 in the weft direction.

4. A free-standing cargo management device for vehicle flooring comprising a primary wall and a projecting ground wall extending from the primary wall, where the surface of the ground wall that is configured to contact the vehicle flooring includes a layer of a warp-knit structure having knitted loops, said layer having a thickness of 2.0 mm to 4.0 mm, a fiber denier of 2-20 and 450-625 spines/inch and wherein 50% or more of the knitted loops are cut or sheared;
wherein said layer of warp-knit structure indicates a static coefficient of friction under ASTM D1894-11 on:
(v) non-woven flooring of 5-10 in the warp direction and 4-7 in the weft direction; and
(vi) tufted flooring of 2.5-4.0 in the warp direction and 2.5-4.0 in the weft direction.
